(19) United States
(12) Patent Application Publication
(10) Pub. No.: US 2010/0237577 A1
(43) Pub. Date: Sep. 23, 2010

(54) APPARATUS AND METHODS FOR MOVING STORE FIXTURES AND GONDOLAS

(76) Inventor: Wahn Russell Bolster, Rogers, MN (US)

Correspondence Address: Antonio Papageorgiou, Esq.;Papageorgiou & Associates, 3050 Fairfield Avenue #3G, Bronx, NY, 10463, US

(21) Appl. No.: 12/727,869

(22) Filed: Mar. 19, 2010

Related U.S. Application Data
(60) Provisional application No. 61/210,571, filed on Mar. 20, 2009.

(51) Int. Cl. B62B 3/00

(52) U.S. Cl. 280/79.7

(57) ABSTRACT

An apparatus and method is disclosed for moving store fixtures and gondolas without de-merchandising the units. The device having a cross member (24) connected to a tongue (34) that raise and lower the units by themselves or by a set of attachments comprised of left arm (20) and a right arm (22) here to connected to attachment left (50) and attachment right (52) and having a set of casters (26) to transport the units. The attachments having a plurality of lower fingers (54), upper fingers (56) and a mouth (58) that universally connect with store fixtures and gondolas to assist in transporting them.

### RELATED APPLICATION

This application claims priority to U.S. Provisional Application No. 61/210,571, filed Mar. 20, 2009, which is hereby incorporated herein by reference.

### BACKGROUND OF THE INVENTION

This application relates generally to a device for moving store fixtures and gondolas, specifically to move them without de-merchandising the units.

Over the past three decades there has been an increased popularity in chain stores and supermarkets. Stores of this nature display, for sale, a variety of products in a multiple of categories. Merchandise in stores of this type is displayed in various departments primarily on gondolas and other store fixtures. Gondolas are a form of store shelving constructed of heavy metal, with peg board for backing, and usually come in 48 inch wide sections. In many instances gondolas are double-sided. It is customary to link gondola sections together, sometimes into lengths of up to 28 feet, or more. Gondolas arrive at a store location in many pieces and are set up by those skilled in this art. Then store personnel stock the shelves with merchandise.

In the life of a chain store or supermarket, remodeling and upgrading happen every three to five years. Seasonally departments are rearranged to coincide with the buying patterns of the stores customers. When construction has to take place and when stores have to be rearranged, gondolas and other store fixtures must be moved. In some instances moving of a gondola may have to occur many times. Presently, when gondolas have to be moved, the procedure is to have store personnel de-merchandise the units. Then, skilled personnel dismantle the gondola and move it to a new location. The gondola must be set up, once again, and store personnel stock merchandise on the gondola. Every time a gondola or store fixture must be moved, this occurs at great expense of time, labor and other cost.

In the past, contractors have tried to save cost by jacking up long sections of gondolas and inserting carts and dollies under the gondola. This method has proved it is not an effective safe method. At times it has been a costly mistake. Gondolas have tipped over bending the unit out of shape. Personnel have been injured. Merchandise has fallen from the shelves requiring it to be restocked. In some instances the merchandise is even rendered un-saleable.

Some manufacturers have offered for sale various configurations of angle irons and casters to mount under their store fixtures. While in some instances this can offer mobility to some store fixtures, for the most part it does not solve the problem in moving the gondolas and store fixtures that are routinely used in chain stores and supermarkets today. Gondolas and store fixtures with stable bases are preferred for day to day operations of a retail store.

To offer other examples, U.S. Pat. No. 5,924,168 Caster Assembly Mechanism, inventors Web and Burke, only addresses the lifting and roll transporting of columns of support racks for warehouse pallet racks; U.S. Pat. No. 7,438,301 Apparatus And Methods For Moving Storage And Display Systems, inventors Schilling and Rosenband, does not address the issue of having to de-merchandise the shelving assemblies prior to moving them; and patent publication number 2007/0194546 A1 Lifting System For Display Cases, inventor Cozza, uses force that can pinch and damage the center posts of store fixtures and gondolas, which are hereby incorporated herein by reference.

From the above, it can be seen what is needed is a device that is easy-to-use to move linked sections of a variety of gondolas and others store fixtures stocked with merchandise.

### SUMMARY OF THE INVENTION

The present invention is an apparatus and method simple and easy to use to move store fixtures and gondolas. The carriage can be used to move a variety of gondolas and store fixtures made by various manufacturers.

There are many objects of the present invention in its various embodiments that may be addressed individually or in combinations and permutations. Each embodiment may address one or several of the following objectives.

An object of this invention in one embodiment or variant of the invention is to provide a device for safely transporting gondolas and store fixtures.

Another object of this invention in one embodiment or variant of the invention is to provide a device for easily transporting gondolas and store fixtures stocked with merchandise.

Another object of this invention in one embodiment or variant of the invention is to provide a device for easily transporting gondolas and store fixtures stocked with 90 percent of its merchandise.

Another object of this invention in one embodiment or variant of the invention is to provide a device for quickly transporting gondolas and store fixtures stocked with merchandise.

Another object of this invention in one embodiment or variant of the invention is to provide a device for transporting all types of gondolas and store fixtures.

Another object of this invention in one embodiment or variant of the invention is to provide a device for economically transporting gondolas and store fixtures stocked with merchandise.

These and other objects and advantages of the invention will be clear in view of the following description to the invention including the associated drawings.

One or more of the objects discussed herein are achieved with an apparatus for moving a gondola or store fixture, the apparatus that includes a cross member having a planer horizontal surface and a hole disposed in the cross member through the planar surface; at least one caster attached to the cross member below the planer surface of the cross member; at least one tongue having a planer horizontal surface and a threaded portion, the tongue extending outward from the device; at least one vertical guide affixed to one of the cross member and the tongue and disposed relative to the tongue to prevent the tongue from rotating; and at least one threaded rod or bolt that passes through the hole disposed in the cross member and that engages the threaded portion of the tongue to allow the tongue to move vertically as the rod or bolt is screwed into or out of the threaded portion of the tongue.

In at least one embodiment, the vertical guide is affixed to the tongue and one end of the cross member abuts against the vertical guide with a complimentary shape to prevent the tongue from rotating. In this instance, the apparatus further includes a plurality of clips with an open end that allows the clips to fit over opposite ends of the tongue laterally. The clips further have a slot that engages the tongue and a kick panel associated with a gondola or store fixture, and when attached thereto prevents the kick panel from moving longitudinally relative to the tongue.

In at least one embodiment, the vertical guide extends below the planer horizontal surface of the cross member.

In at least one embodiment, an apparatus for moving a gondola or store fixture is provided that includes a plurality of cross members; a longitudinal member, wherein the plurality of cross members are coupled to each other with the longitudinal member, a first of the plurality of the cross members is disposed on a first end of the longitudinal member and a second of the plurality of cross members is disposed on an opposite side of the longitudinal member, the longitudinal member further has at least one planer horizontal surface and a hole disposed therein on each of the ends of the longitudinal member through the planar surface; a plurality of casters attached to each of the cross member below the planer surface of the longitudinal member; at plurality of tongues, at least one of the plurality of the tongues disposed on a first end of the device and another of the plurality of the tongues disposed on a second end of the device opposite the first end, each of the tongues having a planer horizontal surface and a threaded portion, the tongue extending outward from the ends of the device; at least one vertical guide disposed on each of the ends of the device, the tongues disposed relative to the respective vertical guide to prevent the tongues from rotating; and a threaded rod or bolt that passes through each of the holes disposed in the longitudinal member and that engages the threaded portion of the tongue to allow the tongue to move vertically as the rod or bolt is screwed into or out of the threaded portion of the tongue.

In at least one embodiment, the vertical guides are three-sided vertical guide and the tongue is at least partially disposed within the three sides of the vertical guide. In this instance, the vertical guide may extend below the horizontal surface of the longitudinal member.

In at least one embodiment, the longitudinal member includes a left leg and a right leg coupled to each other to form the longitudinal member. The left and right arms may further be extendably coupled to each other. One of the left and right arms may include a plurality of attachment bars each having a slot therein that allows the other of the arms to mate with the arm. The slots, for example, may have an opening that allows the other arm to slide into the arm laterally.

In at least one embodiment, each of the tongues having a protruding member uniformly notched.

In at least one embodiment, the apparatus includes a left attachment and a right attachment, each of the attachments having a first set of uniformly spaced fingers extending outward from the attachment and a mouth disposed therein. The fingers may extend upwardly. Each attachment may further include another set of uniformly spaced fingers, spaced different from the first set of fingers. The first set of fingers may extend from a first side of the attachment and the other set of fingers extend out of a second side of the attachment opposite the first side.

### BRIEF DESCRIPTION OF THE DRAWINGS

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. All Figures are drawn for ease of explanation of the basic teachings of the present invention only; the extensions of the Figures with respect to number, position, relationship, and dimensions of the parts to form the preferred embodiment will be explained or will be within the skill of the art after the following description has been read and understood. Further, the exact dimensions and dimensional proportions to conform to specific force, weight, strength and similar requirements will likewise be within the skill of the art after the following description has been read and understood.

FIG. 1 is a perspective view of a gondola and store fixture moving device according to at least one embodiment of the moving devices discussed herein.

FIG. 2 is a front elevation view of a left arm of the moving device according to at least one embodiment of the moving devices discussed herein.

FIG. 3 is a front elevation view of a right arm of the device according to at least one embodiment of the moving devices discussed herein.

FIG. 4 is a plan view of FIG. 2.

FIG. 5 is a plan view of FIG. 3.

FIG. 6 is a side elevation view of a left attachment according to at least one embodiment of the moving devices discussed herein.

FIG. 7 is a side elevation view of a right attachment according to at least one embodiment of the moving devices discussed herein.

FIG. 8 is a plan view of the attachments according to at least one embodiment of the moving devices discussed herein.

FIG. 9 is a plan view of a tongue according to at least one embodiment of the moving devices discussed herein.

FIG. 10 is a perspective view of a gondola.

FIG. 11 is an elevation view of a gondola with the moving device placed under the gondola for use in accordance with at least one embodiment of the methods of use discussed herein

FIG. 12 is an elevation view of a gondola and the moving device placed under the gondola for use in accordance with another method of use.

FIG. 13 is a plan view of the fixture base of FIG. 12.

FIG. 14 is a gondola base plan view of a gondola and the moving device placed under the gondola for use in accordance with another method of use.

FIG. 15 is a perspective view of another embodiment of the devices discussed herein.

FIG. 16 is a view of the embodiment shown in FIG. 15, in use.

### DRAWINGS REFERENCE NUMERALS

20 left arm
22 right arm
24 cross member
26 caster
28 carriage bolt
30 vertical guide
32 gusset
33 guide
34 tongue
36 double nut
37 hex nut
38 threaded rod
40 alignment bar
50 attachment left
52 attachment right
54 lower fingers
56 upper fingers
58 mouth
60 hex socket
62 cordless drill
70 gondola foot
72 kick plate
74 center post
76 bottom slot
78 shelve slot
80 peg board
82 base deck
84 shelve
86 post foot
88 mesh
90 clip
92 end cap
94 lift bar

### DETAILED DESCRIPTION

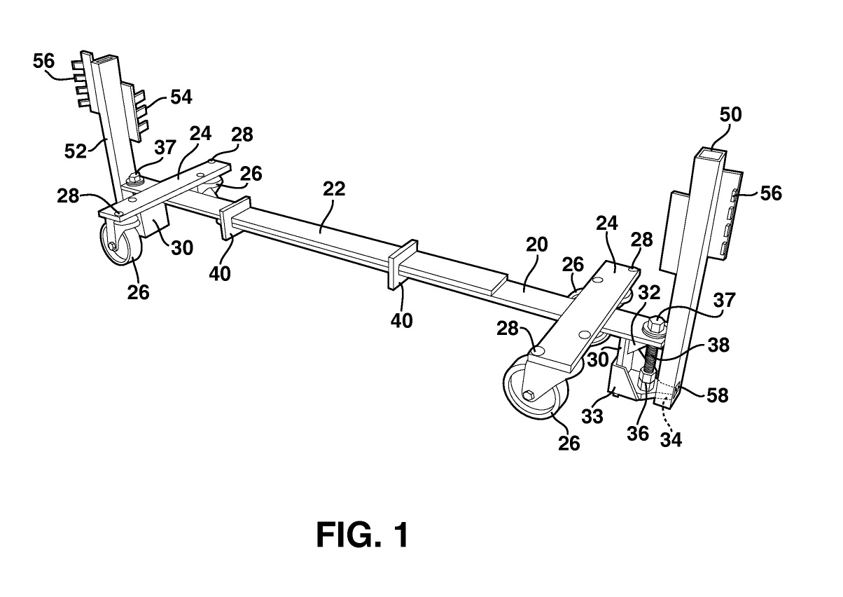

One or more embodiments of the moving devices discussed herein will now be described, by way of example, with reference to the accompanying drawings. FIG. 1 is a perspective view of a gondola and store fixture moving device according to at least one embodiment of the moving devices discussed herein. The device is comprised of a longitudinal member, which may include a left arm 20 and a right arm 22. The left and right arms may be extendably coupled to each other. The arms may be constructed from A-36 mild steel or any rigid material suitable for this means. Cross members 24 are respectively welded, bolted, or otherwise connected to left arm 20 and right arm 22 by any suitable means. A plurality of casters 26 are attached to each of the cross members 24 by carriage bolts 28 or other suitable means. Vertical guides 30 are welded or otherwise affixed to left arm 20 and right arm 22. The vertical guides 30 may extend below the left 20 and right 22 arms, as shown, or otherwise. Gusset 32 may be used to reinforce the connection between left arm 20, right arm 22, and the vertical guide 30. This connection is made by welding or any other by suitable means of connection. A plurality of guides 33 are welded to the vertical guides 30. That is, a first of the plurality of the guides 33 is attached to one of the sides of the vertical guide 30 and a second of the plurality of the guides 33 is attached to the other of the vertical guide 30, therewith forming a three sided vertical guide.

A tongue 34 is disposed at least partially within the three sided vertical guide such that the three sided vertical guide restrains the tongue 34 from rotating therein while allowing the tongue 34 to slide vertically within the three sided vertical guide. Tongue 34 has a permanently affixed double nut 36 attached thereto or otherwise has threads for a threaded rod or bolt 38 to engage. Hex nut 37 may be permanently attached to the threaded rod 38 or the hex nut 37 may be the head of the bolt 38. The threaded rods or bolts 38 pass through the opposing ends of the device, e.g., through holes disposed therein. That is, the threads of the rod or bolt 38 do not engage with the longitudinal member and/or the cross member thereby allowing the clockwise and counter clockwise turning of hex nut 37 to raise and lower the tongue 34 in a vertical fashion. Casters 26 universally mobilize the device in a planar manor when forces are applied to the device and/or the gondola.

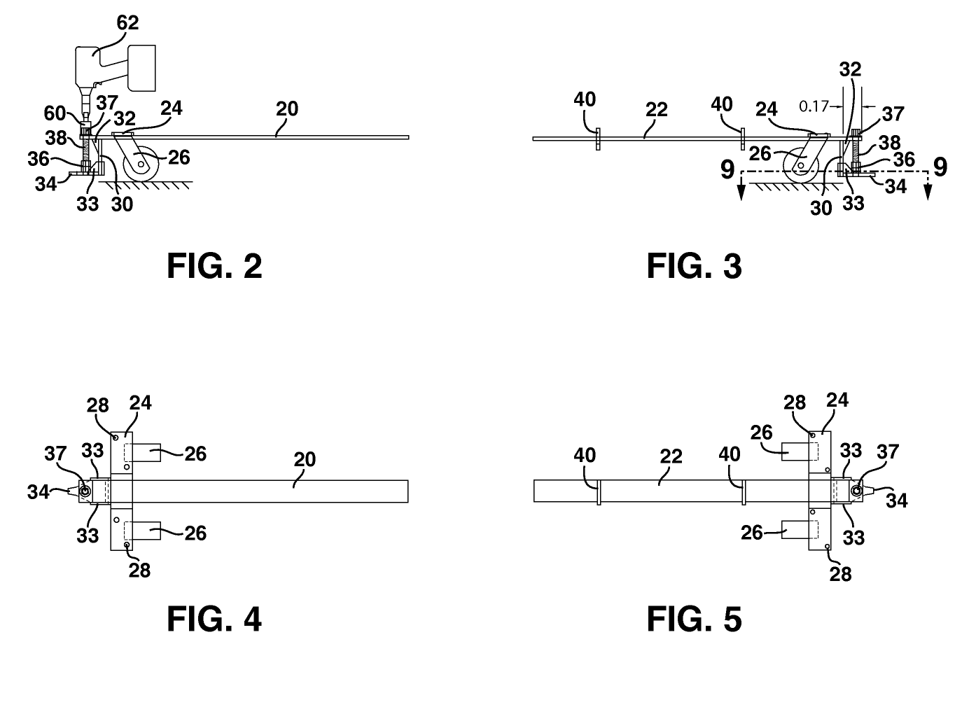

FIG. 2 is a front elevation view of a left arm of the moving device. FIG. 3 is a front elevation view of a right arm of the device. In FIG. 3 a plurality of attachment bars 40 are illustrated. Attachment bars 40 are welded or otherwise attached to right arm 22 and form a slot for the left arm 20 to engage and mate with right arm 22. The left arm 20 may pass through the slot in the attachment bars 40 in a non-fixed relationship at least longitudinally to allow the longitudinal member to extend. The slot may have a “C” shape to allow the left arm to slide into the right arm laterally in the minor direction. FIG. 4 is a plan view of FIG. 2, and FIG. 5 is a plan view of FIG. 3. It is understood that the three sided vertical guide may extend the length of the vertical guide 30, e.g., from the bottom of the tongue 34 up to the bottom of the cross member 32, not partially as shown.

FIG. 9 is a plan view of the tongue 34 disposed within the three sided vertical guide. This view depicts the relationship of vertical guide 30 with guides 33 and their relationship to tongue 34 and double nut 36. Tongue 34 is typically 0.2 of a foot by 0.29 of a foot and uniformly notched to form a protruding member. That is, a member that protrudes outward from the three sided vertical guide. In operation, the opposite ends of the three sided vertical guide maintain the relationship of the tongue 34 in the vertical guide as the tongue 34 slides vertically therein.

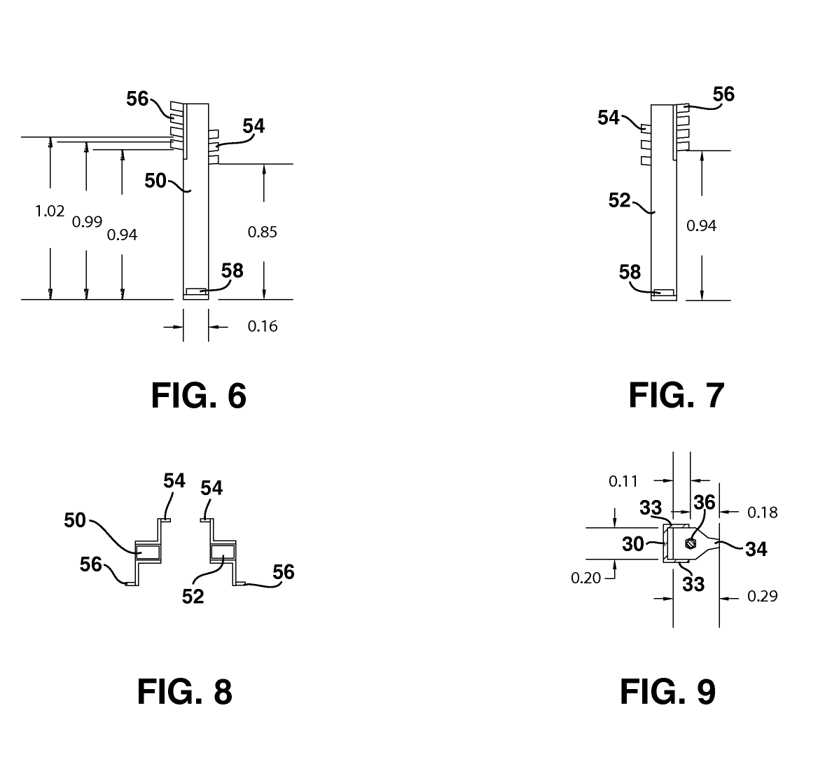

FIG. 6 is a side elevation view of a left attachment. FIG. 7 is a side elevation view of a right attachment. FIG. 8 is a plan view of the attachments. FIGS. 6 through FIG. 8 illustrate attachment left 50 and attachment right 52. The attachments may include lower fingers 54, upper fingers 56, and a mouth 58. The fingers 54, 56 may extend upwardly as shown. That is, height of the fingers at the base may be smaller than the height of the fingers at the outer most point. The lower fingers generally extent out of a first side of the attachment and the upper fingers extend out of a second side of the attachment opposite the first side.

Attachment left 50 and attachment right 52 are constructed from A-36 mild steel or any rigid material suitable for this means. The mouth 58 is typically 0.16 of a foot wide. The lower fingers 54 are positioned 0.85 of a foot from the base of the attachment. The upper fingers 56 are positioned 0.94 of a foot from the base of the attachment. The lower fingers 54 and the upper fingers 56 are 0.05 of a foot in height. The fingers are spaced 0.03 of a foot apart. The lower fingers 54 are positioned at a height to mate with standard shelve slots 78 on gondolas manufactured By Lozier Inc., as well as other manufacturers. The upper fingers 56 are positioned at a height to mate with standard shelve slots 78 on gondolas manufactured by Streater Inc. as well as other manufacturers. It is understood that various other dimensions may be used instead for the device to be used with gondolas manufactured by others.

It is noted, in one embodiment, the device is configured with strong consideration to a left hand and a right-hand, its opposite, construction. This consideration is further emphasized by painting components with a left hand consideration blue and components with a right hand consideration painted black. Of course any varied colors could be used to accomplish this same means of differentiation.

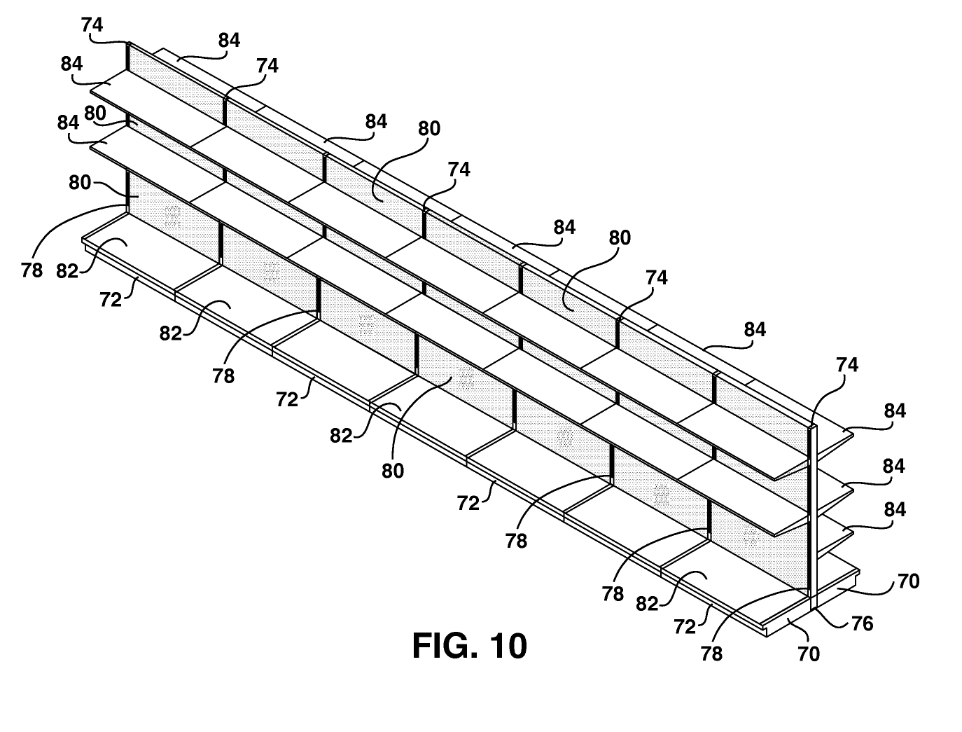

FIG. 10 is a perspective view of a gondola. Gondolas are typically constructed from steel and have a base comprised of a gondola foot 70, a kick plate 72 and a base deck 82. The 48 inch kick plates can only be removed when the gondola foot 70 is raised from the floor. The gondola foot 70 is usually of various sizes and attaches into place on the center post 74. Center posts 74 extend vertically from the base at 48 inch increments. They typically are 54 to 120 inches in height. Pegboard 80 is positioned between the center posts 74. Shelves 84 connect to the center posts 74 at incremental placed shelve slots 78. The shelve slots 78 start near the base deck 82 and extend to the top of the center post 74. The bottom slot, of the shelve slots 78, near the base deck on the center posts 74 is where the attachment left 50 and attachment right 52 are placed. The exposed ends of gondolas also have a bottom slot 76. At times the tongue 34 of the device can be inserted into bottom slot 76 to raise the gondola. The carriage is positioned to operate from a position centrally located under the pegboard 80 and between the center posts 74.

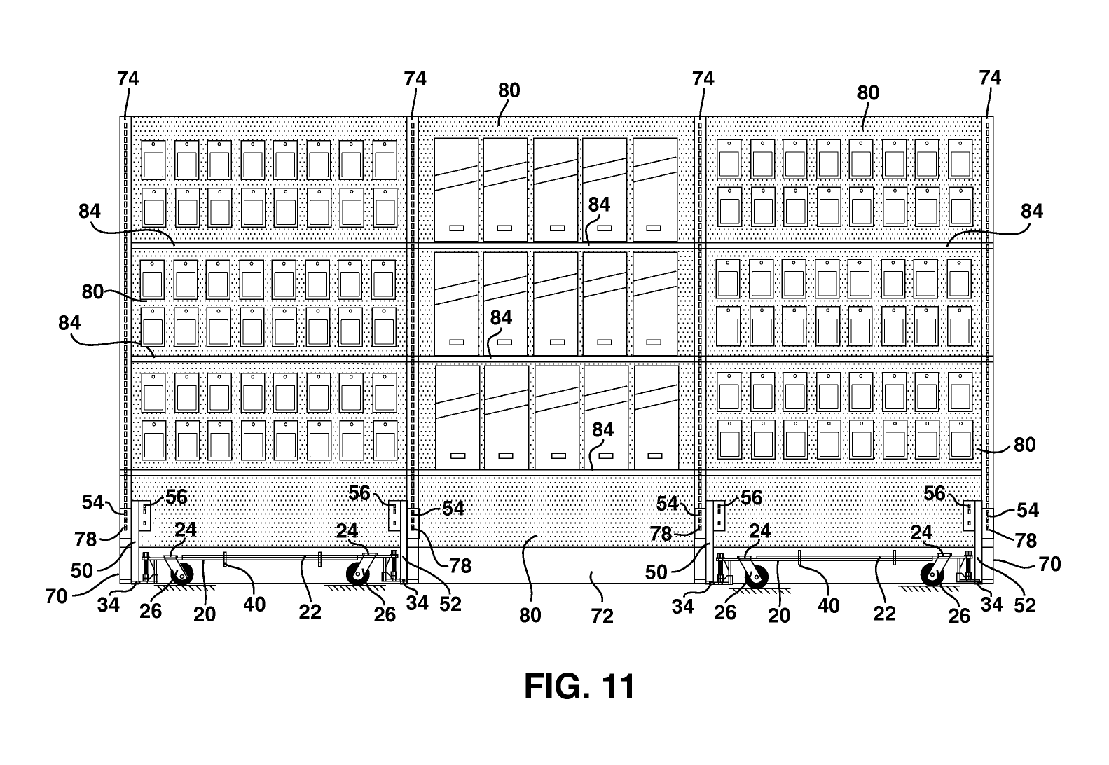

Operation—FIG. 11 through FIG. 14 and FIG. 16.

FIG. 11 is an elevation view of a gondola with the moving device placed under the gondola for use in accordance with at least one of the methods of use discussed herein. The base deck 82 is first removed from only the portion where the apparatus is to be used. If the shelves 84 are not less than 12 inches off the face of the base deck 82, then no merchandise and or shelf will have to be removed. The apparatus is placed under the gondola in the following manner.

Attachment left 50 and attachment right 52 are placed first on to the center posts 74 of the gondola at lower shelve slots 78 with the mouth 58 facing inwardly. That is, the fingers with the desired spacing are generally inserted into the shelve slots 78. The right arm 22 may then be placed so that the tongue 34 of the right art 22 inserts into the inwardly facing mouth 58 of the right attachment 52. The left arm 20 may then be placed so that tongue 34 inserts into the inwardly facing mouth 58 of the left attachment 50. The user then skips 48 inches and places another apparatus on either side of the next gondola for distributing the weight evenly. The above mentioned process is repeated and followed in a consecutive fashion.

Then starting with a left arm 20 a cordless drill 62 with a 15/16 inch or appropriately sized hex socket 60, or other means, is used to turn hex socket 37 in a clockwise direction just enough to raise the gondola off the floor. Each consecutive apparatus will be raised in the same way to the same height, just clearing the floor. The base deck 82 components are then slid back into place up against the left attachment 50 and right attachment 52. This assists the gondolas to stay rigid and straight when moved to the new location traveling on casters 26. When moved to the new location the base deck 82 components are removed. Hex nuts 37 are turned in a counterclockwise direction lowering the gondola back to the floor where the apparatus is then removed and the base deck 82 restored to its original position.

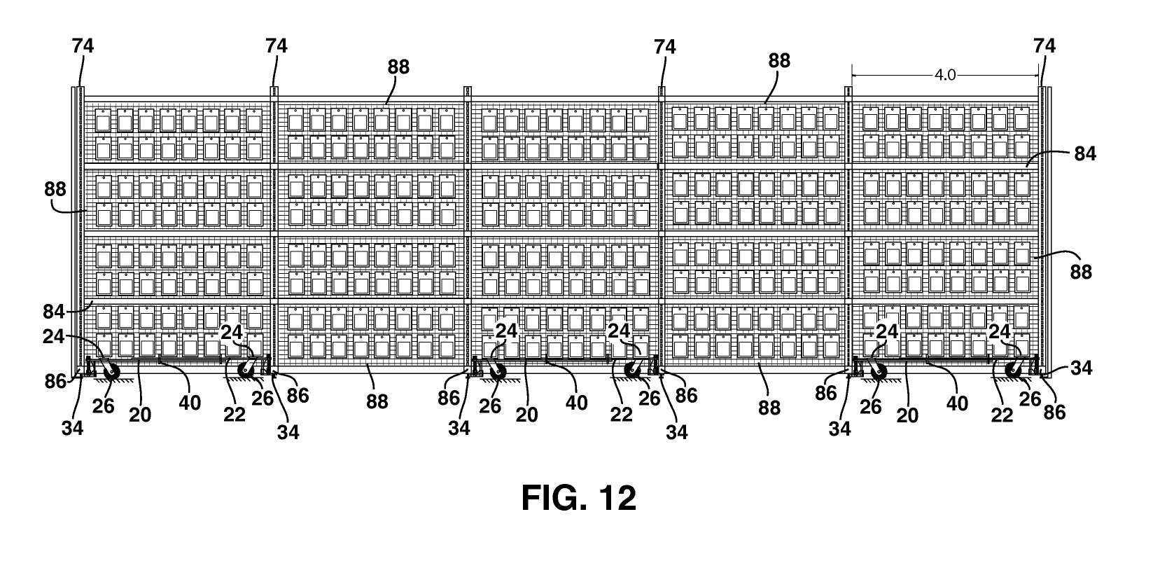

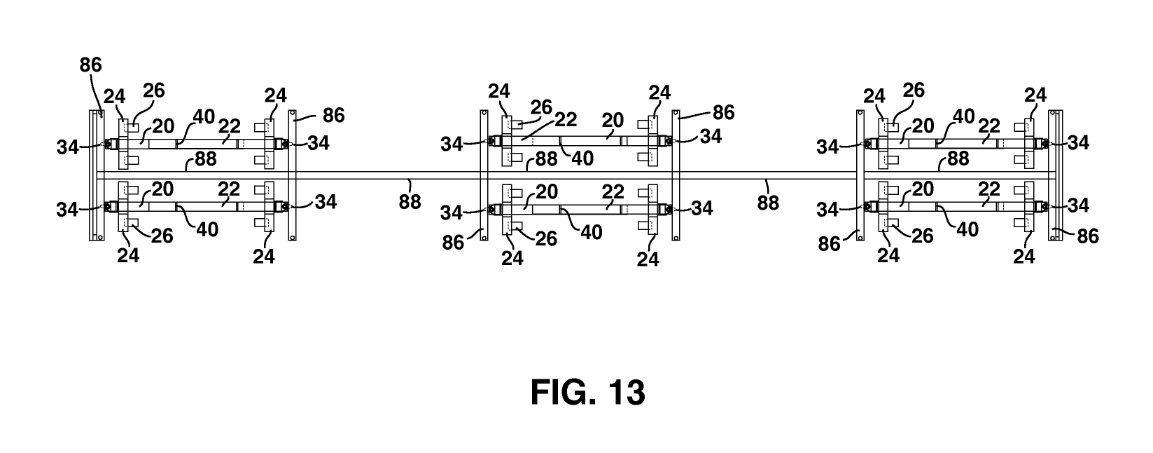

FIG. 12 is an elevation view of a gondola with the device placed there under for use according to another method of using the device. This is an example of another type of store fixture without base decks 82. These fixtures typically have heavy metal mesh 88 in lieu of pegboard 80. FIG. 13 is a plan view of the fixture base of FIG. 12. In this method the attachment left 50 and attachment right 52 are not used. The procedure is started by placing right arm 22 where tongue 34 makes contact to the bottom of post foot 86. The left arm 20 is then placed where tongue 34 makes contact to the bottom of post foot 86. You then skip 48 inches and place the apparatus on each side of the gondola for distributing the weight evenly. The above mentioned process is repeated and followed in a consecutive fashion. Then starting with a left arm 20 a cordless drill 62 with a 15/16 inch hex socket 60, or other means, is used to turn hex socket 37 in a clockwise direction just enough to raise the gondola off the floor. Each consecutive apparatus will be raised in the same way to the same height, just clearing the floor. The double nut 36 can also be turned and used in the process of raising or lowering the tongue 34. The gondola is then moved by casters 26 to its new location. Hex nuts 37 are turned in a counterclockwise direction lowering the gondola back to the floor where the apparatus is then removed.

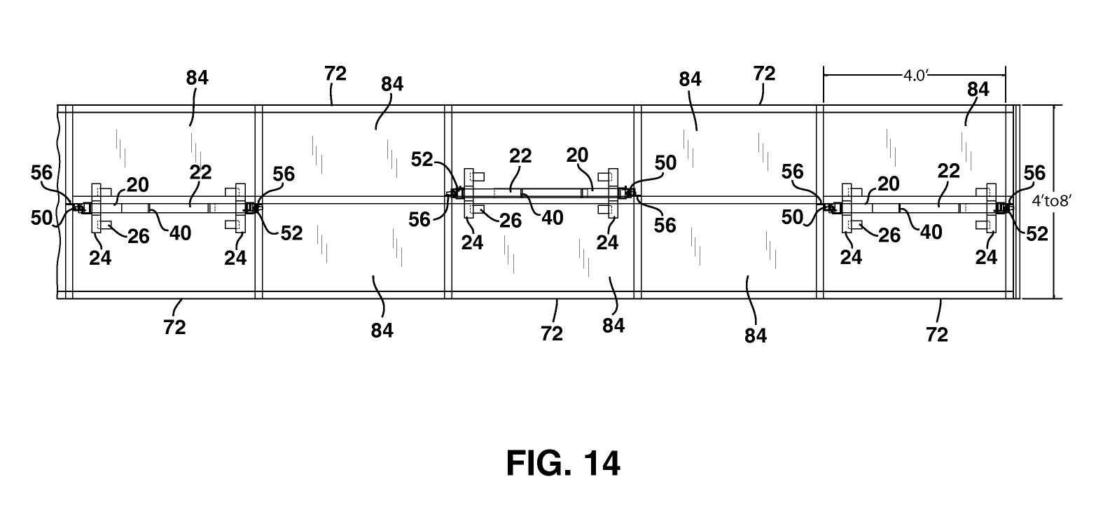

FIG. 14 is a gondola base plan view of another way of using the device. Similar to what is illustrated in FIG. 11.

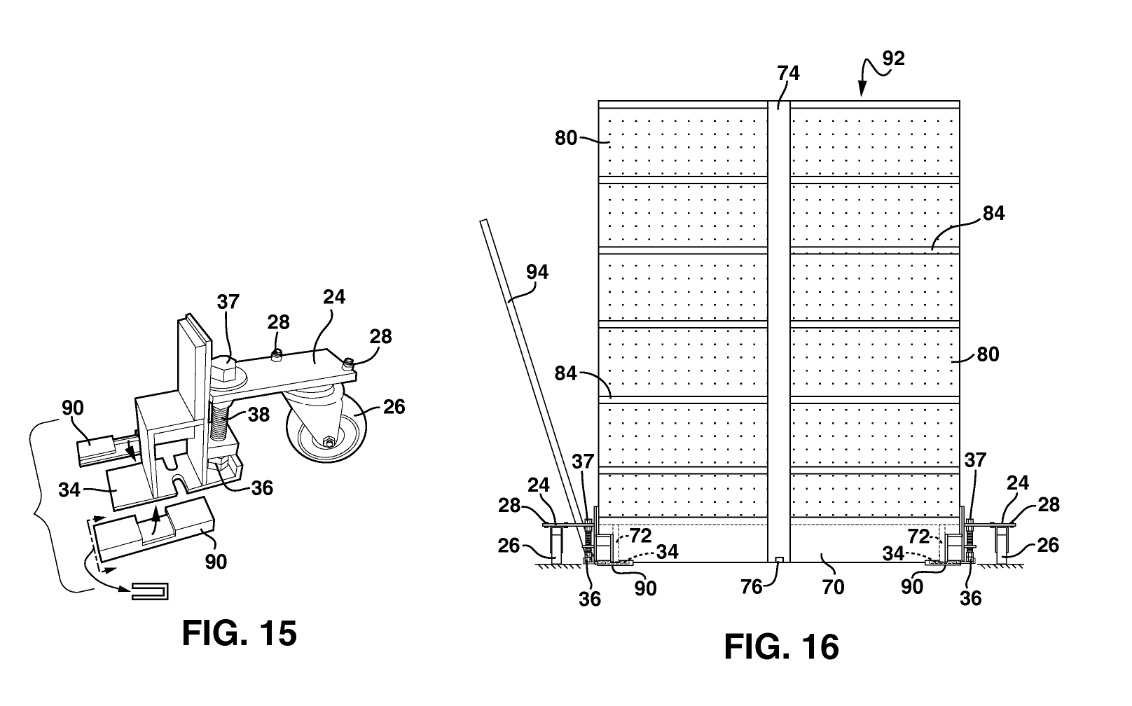

FIG. 15 is a perspective view of another embodiment of the invention. In this embodiment the carriage is comprised of a cross member 24 with a caster 26 attached to cross member 24 by carriage bolts 28 or other means. Hex nut 37 is permanently attached to threaded rod 38 or the head of a bolt. The clockwise and counter clockwise turning of hex nut 37 raises and lowers tongue 34 in a vertical fashion. A loose pair of clips 90 rest on the top surface of tongue 34 from either end of the tongue 34. The clips 90 have an open end so that clips 90 fit over the tongue 34 laterally. The clips 90 may also have a slot on an upper surface to clear bracing portions of the tongue 34. The slot in the clips 90 may further be large enough to engage the kick plate 72. Caster 26 universally mobilizes the device in a planar manor when forces are applied.

FIG. 16 is a view of the embodiment shown in FIG. 15, disposed under a gondola for use. With the use of this embodiment no de-merchandising of shelves is required. A lift bar 94 may be used to raise the gondola, which requires only 58 pounds of down pressure, on its end, to raise 800 pounds of gondola weight. A 0.62 inch thick steel bar is placed about 12 inches under the gondola foot 70, to facilitate safety. The clips 90 and tongue 34 are then inserted under the gondola, such that the tongue 34 slides under the kick plate 72 and the kick plate 72 abuts the vertical wall of the tongue 34. The clips 90 are then slid laterally over the tongue 34 to lock the kick panel 72 in position relative to the tongue 34. That is, the slot in the clips 90 form a step that prevents the kick panel 72 from moving longitudinally. Typically this will occur 16 times on a 28 foot long gondola. This embodiment may be used most frequently on Lozier Gondolas at approximately four foot increments on each side of the gondola. A cordless drill 62 with a 15/16 inch hex socket 60, or other means, may then be used to turn hex socket 37 in a clockwise direction just enough to raise the gondola off the floor. Each consecutive apparatus will be raised in the same way to the same height, just clearing the floor. The raising means, clips 90, and tongue 34 engage to lift the kick plate 72. The 0.62 inch thick steel bars are then removed. Gondola is moved to a new location and the process is reversed to disengage from the gondola. A plurality of devices can be used to move store fixtures and gondolas of any length and in any configuration.

### Advantages

An advantage of this invention in one embodiment or variant of the invention is to provide a device for safely transporting gondolas and store fixtures.

Another advantage of this invention in one embodiment or variant of the invention is to provide a device for easily transporting gondolas and store fixtures stocked with merchandise.

Another advantage of this invention in one embodiment or variant of the invention is to provide a device for easily transporting gondolas and store fixtures stocked with 90 percent of its merchandise.

Another advantage of this invention in one embodiment or variant of the invention is to provide a device for quickly transporting gondolas and store fixtures stocked with merchandise.

Another advantage of this invention in one embodiment or variant of the invention is to provide a device for transporting all types of gondolas and store fixtures.

Another advantage of this invention in one embodiment or variant of the invention is to provide a device for economically transporting gondolas and store fixtures stocked with merchandise. From the description above, a number of advantages of some embodiments of my apparatus and method to move store fixtures and gondolas become evident:

There are many materials and configurations that can be used in constructing the devices disclosed herein by those skilled in the art including various materials, colors and dimensions. In addition, it is clear that an almost infinite number of minor variations to the form and function of the disclosed invention could be made and also still be within the scope of the invention. Consequently, this disclosure is not intended to limit the invention to any specific embodiments and variants of the devices disclosed herein.

I claim:

1. An apparatus for moving a gondola or store fixture, the apparatus comprising:
a cross member having a planer horizontal surface and a hole disposed in the cross member through the planar surface;
at least one caster attached to the cross member below the planer surface of the cross member;
at least one tongue having a planer horizontal surface and a threaded portion, the tongue extending outward from the device;
at least one vertical guide affixed to one of the cross member and the tongue and disposed relative to the tongue to prevent the tongue from rotating; and
at least one threaded rod or bolt that passes through the hole disposed in the cross member and that engages the threaded portion of the tongue to allow the tongue to move vertically as the rod or bolt is screwed into or out of the threaded portion of the tongue.

2. The apparatus of claim 1, wherein the vertical guide is affixed to the tongue and one end of the cross member abuts against the vertical guide with a complimentary shape to prevent the tongue from rotating, the apparatus further comprising a plurality of clips with an open end that allows the clips to fit over opposite ends of the tongue laterally, the clips further having a slot that engages the tongue and a kick panel associated with a gondola or store fixture, and when attached thereto prevents the kick panel from moving longitudinally relative to the tongue.

3. The apparatus of claim 1, wherein the vertical guide extends below the planer horizontal surface of the cross member.

4. An apparatus for moving a gondola or store fixture, the apparatus comprising:
a plurality of cross members;
a longitudinal member, wherein the plurality of cross members are coupled to each other with the longitudinal member, a first of the plurality of the cross members is disposed on a first end of the longitudinal member and a second of the plurality of cross members is disposed on an opposite side of the longitudinal member, the longitudinal member further has at least one planer horizontal surface and a hole disposed therein on each of the ends of the longitudinal member through the planar surface;
a plurality of casters attached to each of the cross member below the planer surface of the longitudinal member;
at plurality of tongues, at least one of the plurality of the tongues disposed on a first end of the device and another of the plurality of the tongues disposed on a second end of the device opposite the first end, each of the tongues having a planer horizontal surface and a threaded portion, the tongue extending outward from the ends of the device;
at least one vertical guide disposed on each of the ends of the device, the tongues disposed relative to the respective vertical guide to prevent the tongues from rotating; and
a threaded rod or bolt that passes through each of the holes disposed in the longitudinal member and that engages the threaded portion of the tongue to allow the tongue to move vertically as the rod or bolt is screwed into or out of the threaded portion of the tongue.

5. The apparatus of claim 4, wherein the vertical guides are three sided vertical guide and wherein the tongue is at least partially disposed within the three sides of the vertical guide.

6. The apparatus of claim 5, wherein the vertical guides extend below the horizontal surface of the longitudinal member.

7. The apparatus of claim 4, wherein the longitudinal member comprises a left leg and a right leg coupled to each other to form the longitudinal member.

8. The apparatus of claim 7, wherein the left and right arms are further extendably coupled to each other.

9. The apparatus of claim 7, wherein one of the left and right arms comprise a plurality of attachment bars each having a slot therein that allows the other of the arms to mate with the arm.

10. The apparatus of claim 9, wherein the slots have an opening that allows the other arm to slide into the arm laterally.

11. The apparatus of claim 4, each of the tongues having a protruding member uniformly notched.

12. The apparatus of claim 4, comprising a left attachment and a right attachment, each of the attachments having a first set of uniformly spaced fingers extending outward from the attachment and a mouth disposed therein.

13. The apparatus of claim 12, wherein the fingers extend upwardly.

14. The apparatus of claim 12, each attachment further comprising another set of uniformly spaced fingers, spaced different from the first set of fingers.

15. The apparatus of claim 13, wherein the first set of fingers extends from a first side of the attachment and the other set of fingers extend out of a second side of the attachment opposite the first side.

16. An apparatus for moving a gondola or store fixture, the apparatus comprising:
a plurality of cross members;
a longitudinal member, wherein the plurality of cross members are coupled to each other with the longitudinal member, a first of the plurality of the cross members is disposed on a first end of the longitudinal member and a second of the plurality of cross members is disposed on an opposite side of the longitudinal member, the longitudinal member further has at least one planer horizontal surface and a hole disposed therein on each of the ends of the longitudinal member through the planar surface;
a plurality of casters attached to each of the cross member below the planer surface of the longitudinal member;
at plurality of tongues having a protruding member uniformly notched, at least one of the plurality of the tongues disposed on a first end of the device and another of the plurality of the tongues disposed on a second end of the device opposite the first end, each of the tongues having a planer horizontal surface and a threaded portion, the tongue extending outward from the ends of the device;
at least one three sided vertical guide disposed on each of the ends of the device, extending below the horizontal surface of the longitudinal member, the tongues disposed at least partially within the three sides of the respective vertical guide to prevent the tongues from rotating;
a threaded rod or bolt that passes through each of the holes disposed in the longitudinal member and that engages the threaded portion of the tongue to allow the tongue to move vertically as the rod or bolt is screwed into or out of the threaded portion of the tongue;
a left attachment and a right attachment, each of the attachments having a first and a second set of upwardly extending uniformly spaced fingers extending outward from the attachment, and a mouth disposed therein that accepts a tongue, wherein the first set of the uniformly spaced fingers has a spacing that is different than that of the second set of fingers, and wherein the first set of fingers extends from a first side of the attachment and the second set of fingers extend out of a second side of the attachment opposite the first side.
